(19) United States
(12) Patent Application Publication
(10) Pub. No.: US 2008/0271641 A1
(43) Pub. Date: Nov. 6, 2008

(54) Hydraulic Binder

(75) Inventors: Suz-chung Ko, Lenzburg (CH); Peter Kruspan, Pratteln (CH); Juraj Gebauer, Veltheim (CH)

Correspondence Address: CHAPMAN AND CUTLER, 111 WEST MONROE STREET, CHICAGO, IL, 60603, US

(73) Assignee: Holcim Ltd., Zurich (CH)

(21) Appl. No.: 11/547,594

(22) PCT Filed: Apr. 5, 2005
(86) PCT No.: PCT/IB2005/000878

§ 371 Date: Oct. 4, 2006

(30) Foreign Application Priority Data
Apr. 5, 2004 (AT) 598/2004

(51) Int. Cl. C04B 14/04; C04B 18/08; C04B 14/10

(52) U.S. Cl. 106/405; 106/483; 106/486

(57) ABSTRACT

In an alkali activated hydraulic binder containing slags and aluminium silicates slag, in particular furnace slag in amounts from ≧20% (w/w), aluminium silicates different from furnace slag such as for example flue-ash and natural aluminium silicates, such as for example basalt, clays, marl, andesite or zeolite, in amounts from 5 to 75% (w/w) and an alkali activator in an amount, which corresponds to a Na₂O equivalent defined as (Na₂O+0.658 K₂O) (ASTM C 150) between 0.7 and 4% (w/w), respectively related to the entire mixture are present in the mixture as constitutive components.

The invention relates to an alkali-activated hydraulic binder containing slags and aluminium-silicates.

The composition and production of super sulphated metallurgical cements is based on the addition of calcium-sulphate to the cement. According to the international organisation for standardisation (ISO) super sulphated cement is defined as a blend of at least 75% (w/w) hackled, granulated furnace slag, large additives of calcium-sulphate (>5% (w/w) SO₃) and at most 5% (w/w) slacked lime, portland-cement clinker or portland-cement.

For the production of super sulphated cement the granulated slag according to the German norm has to contain at least 13% (w/w) Al₂O₃ and has to correspond to the formula (CaO+MgO+Al₂O₃)/SiO₂>1.6. According to Keil an amount of 15 to 20% alumina slag with a minimal modulus of (CaO+CaS+0.5 MgO+Al₂O₃)/(SiO₂+MnO)>1.8 is preferred. According to Blondiau the CaO/SiO₂ ratio has to be between 1.45 and 1.54 and the Al₂O₃/SiO₂ ratio has to be between 1.8 and 1.9.

Lime, clinker or cement are added in order to increase the ph-value in the cement-paste and to enhance the solubility of alumina soil in the liquid phase during the hydratisation of the cement. The hardening of super sulphated metallurgical cement can take place without chemical additives or a specific formation treatment.

The U.S. Pat. No. 5,626,665 discloses a mixed puzzolana for use with portland-cement for the production of a cement like system. The mixed puzzolana contains burned clay and at least one component chosen from the group consisting of at about 2% to at about 30% hard plaster, at about 0% to at about 25% hydrated kiln dust, at about 0% to at about 20% hydrated lime, at about 0% to at about 20% hydrated lime kiln dust, at about 0% to at about 50% flue-ash and at about 0% to at about 5% organic plastificator. The burned lime is present in sufficient amounts in order to yield a mixed puzzolana with a final total weight of 100%. The mixed puzzolana is mixed with portland-cement in a weight-ratio of at about 1:20 to at about 1:1, preferably at about 1:2 to at about 1:3.

In normal portland-cements and metallurgical cements, in which the hydratisation takes place in the liquid phase free of solubilized alumina, the content of calcium-sulphate is restricted to a minor percentage in order to avoid a potential inner decay due to the formation of calcium-sulfo-aluminate (candlot bacilli) as a consequence of the non-solubilized alumina. In these cements the main influence of calcium-sulphate consists in the retarding action, which it excerpts on the setting time. The basicity of the hydrated calcium aluminates as well as the insolubility of the alumina contained in the aluminates depends on the lime concentration in the liquid phase of the cement and this independently from whether the hydrated calcium aluminates in the hardened cement are present in the crystalline form or in the amorphous form. The lime concentration in the liquid phase determines the kind of influence of the calcium-sulphate on the setting time of the cement and the maximal calcium-sulphate amount, which the cement can contain without resulting into inner decay to retarded formation of ettringite.

In super sulphated metallurgical cements the lime concentration in the liquid phase is below the limit of unsolubility of the alumina. Larger additions of calcium-sulphate for the activation of reactions of furnace slag determine the formation of tricalcium-sulfo-aluminate with higher hydraulic activity on the basis of the solubilized lime and the solubilized alumina without resulting in potential decay. The addition of calcium-sulphate to granulated furnace slag does not create expansion-cement but acts as accelerating agent in the formation of hydrated compounds. In super sulphated cement larger portions of calcium-sulphate are not to be considered as troublesome. The tricalcium-sulfo-aluminate, in which they result, in fact rather contribute to an increase of the hydraulic activity instead of causing decay, as it is the case for portland-cement and normal metallurgical cement.

The initial setting and hardening of super sulphated cement goes along with the formation of the high sulphate form of calcium-sulfo-aluminate from the slag components and the added calcium-sulphate. The addition of portland-cement to cement is required for the adjustment of the adequate alkalinity in order to allow for the formation of ettringite. The most important products of hydratisation are the mono- and trisulfo-aluminate-tobermorite-like phase and alumina.

Super sulphated cement in the course of the hydratisation binds to more water than portland-cement. It fulfils all requirements of the norm of cement as to the grinding fineness. It is considered as cement with low calorific value. As any portland- or metallurgical cement it can be used in form of concrete, setting mortar or groove mortar. The conditions to be considered for the use of super sulphated cement are identical with those that are decisive for the mixing and the application of other cements.

For the improvement of alumino silicate-binders it has already been suggested to activate them with alkali and in particular soda-brine or potassium hydroxide brine.

Alkali activated alumino silicate-binders (AAAS) are cement-like materials which are formed by reaction of fine silica- und alumina solids with an alkali- or alkali-salt solution for the production of gels and crystalline compounds. The technology of alkali activation was originally developed by Purdon from 1930 to 1940 who discovered that the addition of alkali to slag yields a rapidly hardening binder.

In contrary to super sulphated cement a large variety of materials (natural or burned lime, slag, flue-ash, belite alluvia, milled stone etc.) can be used as a source for alumino silicate-materials. Different alkali solutions can be used for the production of hardening reactions (alkali hydroxide, silicate, sulphate and carbonate etc.). That means that the sources for AAAS-binders are practically unlimited.

During the alkali activation a high concentration of OH-ions acts on the mixture of the alumino silicates. While in portland- or super sulphated cement-paste a pH>12 is generated due to the solubility of calcium hydroxide, the pH-value in the AAAS-system is beyond 13.5. The amount of alkali, which is in general between 2 to 25% (w/w) alkali (>3% Na₂O), depends on the alkalinity of the alumino silicates.

The reactivity of an AAAS-binder depends on its chemical and mineral composition, the degree of vitrification and the grinding fineness. In general, AAAS-binders can begin to set within 15 min. and on the long run offer a quick hardening and a considerable increase in strength. The setting reaction and the process of hardening are still not completely understood. They go along with the initial leaching of alkali and the formation of slight crystalline calcium hydrosilicates of the tobermorite-group. Calcium-alumino silicates begin to crystallise to form zeolite-like products and consequently alkali-zeolite.

The strength values in the AAAS-system are contributed to the intense crystallisation contact between zeolites and calcium hydrosilicates. The hydraulic activity is improved by an increase of the alkali doses. The relation between the hydraulic activity and the amount of alkali as well as the presence of zeolite in the hydrated product has revealed that alkali not only act as simple catalyst but also participate in reactions in the same way as lime and hard plaster and feature a relatively high strength due to a considerable influence of cations.

In numerous studies concerning the activity of silico aluminate materials with alkali and their salts have been reported.

From the WO 00/00448 an activate alumino-silicate-binder has already become known in which for the reduction of high portions of soda brine or potassium brine and for the improvement of the strength values cement kiln dust was applied as the activator. Cement kiln dust hereby was suggested in amounts from 1 to 20% (w/w). The addition of cement kiln dust increases the water demand and hence increases the risk of shrinking cracks.

The invention aims to create an alkali activated hydraulic binder of the initially mentioned kind which features minor lime portions and improved strength-values at an early stage and a reduced water/cement factor, whereby a higher resistance and a reduced susceptibility to the formation of cracks is safeguarded.

To solve this object the binder according to the invention consists in general in that the slag and in particular furnace slag in amounts from ≧20% (w/w) various alumino silicates different from furnace slag, preferably flue-ash and natural alumino silicates, preferably basalt, clays, marl, andesite or zeolite in amounts from 5% to 75% (w/w) and an alkali activator in an amount which corresponds to Na2O equivalent defined as (Na₂O+0.658 K₂O) (ASTM C 150) between 0.7 and 4% (w/w) is present. Surprisingly it has turned out that, when using the alkali activator in the specified amounts, the portion of furnace slag can be lowered down to 20% (w/w) and still adequate strength values at an early stage can be achieved. Such a lowering of a portion of furnace slag particularly is effected with the preferred alumino silicates as for example flue-ash and natural aluminium silicates like basalt, whereby with the binder according to the invention at the same time the advantage is achieved that the portion of CaO in the mixture can be considerable lowered. The lowering of the CaO content brings about that the CO₂ formation during production of such a binder is considerably reduced and that hence the production becomes more ecologically friendly. The substitute of furnace slag by aluminium silicates simultaneously brings about that the shrinking performance in the beginning of the hardening process is importantly improved whereby the water demand is reduced and the alkali-aggregate reactivity is reduced. All these properties lead to a particularly durable and fatigue endurable product.

In a particularly preferred manner according to the invention alkali hydroxides, -silicates, -carbonates and/or sulphates from Na and/or K are applied as alkali activator. Advantageously the mixture can hereby additionally be supplied with limestone and/or quartzes with the requirement that the Al₂O₃-content of the mixture is ≧5% (w/w).

The shrinking performance and hence the increase lowered resistance can in particular be improved thereby, that for the reduction of the water/cement ratio plastification agent- and/or superliquefiers in amounts from 0.1 to 1% (w/w) related to the dry substance are added whereby preferably as setting accelerator portland-cement clinker is additionally used in amounts between 0.1 and 5% (w/w) in order to safeguard adequately high strength values at an early stage.

While normally the addition of portland-cement clinker improves the strength values at an early stage, such an additive can be abandoned if the alkali activated hydraulic binder according to the invention is subjected to a heat treatment. Advantageously a binder with high strength at an early stage is hereby provided which stands out thereby that the mixture is heat treated at temperatures below 50° C., preferably between 40° C. and 50° C., more than 3 hours, preferably 4 to 6 hours. Surprisingly such a heat treatment brings about that also with complete abandonment of portland-cement clinker comparable strength values at an early stage can be achieved already after one day. As the activator sodium silicate can be applied in a particularly advantageous manner.

In the following the invention will be explained in more detail by means of exemplary embodiments.

In table 1 three examples of possible compositions of the binder according to the invention and the resulting strength values at an early stage are listed.

| Example | | 1 | 2 | 3 |
|---|---|---|---|---|
| Furnace slag | % | 69 | 46 | 23 |
| Flue-ash | % | 23 | 46 | 69 |
| Na₂SiO₃•5H₂O | % | 6 | 6 | 6 |
| KOH | % | 2 | 2 | 2 |
| Water/cement factor | | 0.34 | 0.32 | 0.31 |
| CS 1 day | MPa | 22.1 | 21.4 | 12.3 |
| CS 2 days | MPa | 28.5 | 28.1 | 20.0 |
| CS 28 days | MPa | 55.9 | 54.2 | 37.2 |

Table 2 presents three additional exemplary embodiments from which the improvement of the strength at an early stage by the addition of Portland-cement clinker or by the heat treatment can be seen.

| Example | | 1 | 2 | 3 |
|---|---|---|---|---|
| Furnace slag | | 45.5 | 43.0 | 45.5 |
| Basalt | % | 45.5 | 43.0 | 45.5 |
| Na₂SiO₃•5H₂O | % | 9 | 9 | 9 |
| Portland-cement clinker | % | — | 5 | — |
| Temperature treatment | % | normal | normal | 40° C. (6 h) |
| Water/cement factor | | 0.33 | 0.32 | 0.35 |
| CS 1 day | MPa | 1.3 | 21.6 | 20.3 |
| CS 2 days | MPa | 23.9 | 30.6 | 23.8 |
| CS 28 days | MPa | 51.9 | 53.4 | 44.1 |

In FIG. 1 the improvement of the shrinking performance versus time by at least partial replacement of the furnace slag by flue-ash can be seen.

FIG. 2 shows the increasing suppression of the alkali-silica-reactivity caused by the replacement of furnace slag by basalt, whereby OPC means portland-cement clinker and BFS means furnace slag. ASR demarks the alkali-silica-reactivity.

1. Alkali activated hydraulic binder comprising slag and aluminum silicates, wherein
the slag is provided in amounts greater than or equal to 20% (w/w);
the aluminum silicates are different from furnace slag, and are provided in amounts from 5 to 75% (w/w); and
an alkali activator is provided in an amount which corresponds to a Na₂0 equivalent defined as (Na₂0+0.658 K₂0) (ASTM C 150) between 0.7 and 4% (w/w) is present.

2. Alkali activated hydraulic binder according to claim 1, wherein the alkali activator is one or more selected from the group consisting of alkali hydroxide, alkali-silicate, alkali-carbonate sulphates of Na, and sulphates of K.

3. Alkali activated hydraulic binder according to claim 1, further comprising one or more selected from the group consisting of limestone and quartzes, and wherein an Al₂0₃—content of the binder is greater than or equal to 5% (w/w).

4. Alkali activated hydraulic binder according to claim 1, further comprising, for the reduction of a water/cement ratio, one or more selected from the group consisting of plastification agent and super liquefiers, which are provided in amounts from 0.1 to 1% (w/w) relative to dry substances in the binder.

5. Alkali activated hydraulic binder according to claim 1, wherein portland-cement clinker is provided in amounts between 0.1 and 5% (w/w) as a setting accelerator.

6. Method for the production of an alkali activated hydraulic binder according to claim 1, comprising the step of heat treating the mixture at temperatures below 50° C. for 4 to 6 hours.

7. Alkali activated hydraulic binder according to claim 1, wherein the slag is furnace slag.

8. Alkali activated hydraulic binder according to claim 1, wherein the aluminum silicates are one or more selected from the group consisting of flue-ash, natural aluminum silicates, basalt, clays, marl, andesite and zeolite.

9. Alkali activated hydraulic binder according to claim 2, further comprising one or more selected from the group consisting of limestone and quartzes, and wherein an Al₂0₃—content of the binder is greater than or equal to 5% (w/w).

10. Alkali activated hydraulic binder according to claim 2, further comprising, for the reduction of a water/cement ratio, one or more selected from the group consisting of plastification agent and super liquefiers, which are provided in amounts from 0.1 to 1% (w/w) relative to dry substances in the binder.

11. Alkali activated hydraulic binder according to claim 3, further comprising, for the reduction of a water/cement ratio, one or more selected from the group consisting of plastification agent and super liquefiers, which are provided in amounts from 0.1 to 1% (w/w) relative to dry substances in the binder.

12. Alkali activated hydraulic binder according to claim 2, wherein portland-cement clinker is provided in amounts between 0.1 and 5% (w/w) as a setting accelerator.

13. Alkali activated hydraulic binder according to claim 3, wherein portland-cement clinker is provided in amounts between 0.1 and 5% (w/w) as a setting accelerator.

14. Alkali activated hydraulic binder according to claim 4, wherein portland-cement clinker is provided in amounts between 0.1 and 5% (w/w) as a setting accelerator.

15. Method for the production of an alkali activated hydraulic binder according to claim 6, wherein the heat treating of the mixture is conducted at temperatures between 40° C. and 50° C. for three hours.

16. Alkali activated hydraulic binder according to claim 7, wherein the aluminum silicates are one or more selected from the group consisting of flue-ash, natural aluminum silicates, basalt, clays, marl, andesite and zeolite.
